(19) United States
(12) Patent Application Publication
(10) Pub. No.: US 2007/0174290 A1
(43) Pub. Date: Jul. 26, 2007

(54) System and architecture for enterprise-scale, parallel data mining

(75) Inventors: Inderpal Singh Narang, Saratoga, CA (US); Ramesh Natarajan, Pleasantville, NY (US); Radu Sioh, Sound Beach, NY (US)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/335,371

(22) Filed: Jan. 19, 2006

(51) Int. Cl. G06F 17/30

(52) U.S. Cl. 707/10

(57) ABSTRACT

A grid-based approach for enterprise-scale data mining that leverages database technology for I/O parallelism and on-demand compute servers for compute parallelism in the statistical computations is described. By enterprise-scale, we mean the highly-automated use of data mining in vertical business applications, where the data is stored on one or more relational database systems, and where a distributed architecture comprising of high-performance compute servers or a network of low-cost, commodity processors, is used to improve application performance, provide better quality data mining models, and for overall workload management. The approach relies on an algorithmic decomposition of the data mining kernel on the data and compute grids, which provides a simple way to exploit the parallelism on the respective grids, while minimizing the data transfer between them. The overall approach is compatible with existing standards for data mining task specification and results reporting in databases, and hence applications using these standards-based interfaces do not require any modification to realize the benefits of this grid-based approach.

### FIELD OF THE INVENTION

The present invention generally relates to data processing, and more particularly, to a system and method for enterprise-scale data-mining, by efficiently combining a data grid (defined here as a collection of disparate data repositories) and a compute grid (defined here as a collection of disparate compute resources), for business applications of data modeling and/or model scoring.

### BACKGROUND OF THE INVENTION

Data-mining technologies that automate the generation and application of statistical models are of increasing importance in many industrial sectors, including Retail, Manufacturing, Health Care and Medicine, Insurance, Banking and Finance, Travel and Homeland Security. The relevant applications span diverse areas such as customer relationship management, fraud detection, lead generation for marketing and sales, clinical data analysis, risk management, process modeling and quality control, genomic data and micro-array analysis, airline yield-management and text categorization, among others.

### SUMMARY OF THE INVENTION

We have discerned that many of these applications have the characteristic that vast amounts of relevant data can be collected and processed, and the underlying statistical analysis of this data (using techniques from predictive modeling, forecasting, optimization, or exploratory data analysis) can be very computationally intensive (see, C. Apte, B. Liu, E. P. D. Pednault and P. Smyth, “Business Applications of Data Mining,” Communications of the ACM, Vol. 45, No. 8, August 2002).

We have now further discerned that there is an increasing need to develop computational algorithms and architectures for enterprise-scale data mining solutions for many of the applications listed above. By enterprise-scale, we mean the use of data mining as a tightly integrated component in the workflow of vertical business applications, with the relevant data being stored on highly-available, secure, commercial, relational database systems. These two aspects—viz., the need for tight integration of the mining kernel with a business application, and the use of commercial database systems for storage—differentiate these applications from other data-intensive problems studied in the data grid literature (e.g., A. Chervenak, I. Foster, C. Kesselman, C. Salisbury, and S. Tuecke, “Towards an Architecture for the Distributed Management and Analysis of Large Scientific Datasets,” Journal of Network and Computer Application, Vol. 23. pp. 187-200, 2001) or in the scientific computing literature (e.g., D. Arnold, S. Vadhiyar and J. Dongarra, “On the Convergence of Computational and Data Grids,” Parallel Processing Letters, Vol. 11, pp 187-202, 2001).

We now consider the implications and evolution of this data mining approach from the perspectives of the business application, the data management requirements, and the computational requirements respectively.

From the business application perspective, the modeling step involves specifying the relevant data variables for the business problem of interest, marshalling the training data for these features from a large number of historical cases, and finally invoking the data mining kernel. The scoring step requires collecting the data for the model input features for a single case (typically these model input features are a smaller subset of those in the original training data, as the modeling step will eliminate the irrelevant features in the training data from further consideration), and generating model-based predictions or expectations based on these inputs. The results from the scoring step are then used for triggering business actions that optimize relevant business objectives. The modeling and scoring steps would be typically performed in batch mode, at a frequency determined by the needs of the overall application requirements, and by the data collection and data loading requirements. However, evolving business objectives, competitive pressures and technological capabilities might change this scenario. For example, the modeling step may be performed more frequently to accommodate new data or new data features as they become available, particularly if the current model rankings and predictions are likely to significantly change as a result of changes in the input data distributions or changes in the modeling assumptions. In addition, the scoring step may even be performed interactively (e.g., the customer may be rescored in response to a transaction event that can potentially trigger a profile change, so that the updated model response can be factored in at the customer point-of-contact itself). Therefore, in summary, from the business perspective, it is essential to tightly have the data mining tightly integrated into and controlled by the overall vertical business application, along with the computational capability to perform the data mining and modeling runs on a more frequent if not interactive basis.

From the data perspective, many businesses have a central data warehouse for storing the relevant data and schema in a form suitable for mining. This data warehouse is loaded from other transactional systems or external data sources after various operations including data cleansing, transformation, aggregation and merging. The warehouse is typically implemented on a parallel database system to obtain scalable storage and query performance for the large data tables. For example, many commercial databases (e.g., The IBM DB2 Universal Database V8.1, http://www.ibm.com/software/data/db2, 2004) support both the multi-threaded, shared-memory and the distributed, shared-nothing modes of parallelism. However, in many evolving business scenarios, the relevant data may also be distributed in multiple, multi-vendor data warehouses across various organizational dimensions, departments and geographies, and across supplier, process and customer databases. In addition, external databases containing frequently-changing industry or economic data, market intelligence, demographics, and psychographics may also be incorporated into the training data for data mining in specific application scenarios. Finally, we consider the scenario where independent entities collaborate to share data “virtually” for modeling purposes, without explicitly exporting or exchanging raw data across their organizational boundaries (e.g., a set of hospitals may pool their radiology data to improve the robustness of diagnostic modeling algorithms). The use of federated and data grid technologies (e.g., The IBM DB2 Information Integrator, http://www.ibm.com/software/integration, 2004) which can hide the complexity and access permission details of these multiple, multi-vendor databases from the application developer, and rely on the query optimizer to minimize excessive data movement and other distributed processing overheads, will also become important for data mining.

From the computational perspective, many statistical modeling techniques for forecasting and optimization are unsuitable for massive data sets, and these techniques therefore often use a smaller, sampled fraction of the data, which increases the variance of the resulting model parameter estimates; or they use a variety of heuristics to reduce computational time that impacts the quality of the model search and optimization.

A further limitation is that many data mining algorithms are implemented as standalone or client applications that extract database-resident data into their own memory workspace or disk area for the computational processing. The use of client programs external to the data server incurs high data transfer and storage costs for large data sets. Even for smaller or sampled data sets it raises issues of managing multiple data copies and schemas that can be outdated or inconsistent with respect to changing data specifications on the database servers. In addition, the use of a set of external processes for data mining with its own proprietary API's and programming requirements is difficult to easily integrate into the SQL-based, data-centric framework of business applications.

In summary, as analytical/computation applications become widely prevalent in the business world, databases will need to provide the best integrated, data access performance for efficiently accessing and querying large, enterprise-wide, distributed data resources. Furthermore, the computational requirements of these emerging data-mining applications will require the use of parallel and distributed computing for obtaining the required performance. More importantly, the need will emerge to jointly optimize the data access and computational requirements in order to obtain the best end-to-end application performance. Finally, in a multi-application scenario, it will also be important to have the flexibility of deploying applications in a way that maximizes the overall workload performance.

The present invention is related to a novel system and method for data mining using a grid computing architecture that leverages a data grid consisting of parallel and distributed databases for storage, and a compute grid consisting of high-performance compute servers or a cluster of low-cost commodity servers for statistical modeling. The present invention overcomes the limitations of existing data mining architectures for enterprise-scale applications so as to (a) leverage existing investments in data mining standards and external applications using these standards, (b) improve the scalability, performance and the quality of the data mining results, and (c) provide flexibility in application deployment and on-demand provisioning of compute resources for data mining.

The present invention can achieve the foregoing for a general class of data mining kernel algorithms, including clustering and predictive modeling for example, that can be data and compute intensive for enterprise-scale applications. A primary characteristic of data-mining algorithms is that models of better quality and higher predictive accuracy are obtained by using the largest possible training data sets. These data sets may be stored in a distributed fashion across one or several database servers, either for performance and scalability reasons (i.e., to optimize the data access performance through parallel query decomposition for large data tables), or for organizational reasons (i.e., parts of the data sets are located in databases that are owned and managed by separate organizational entities). Furthermore, the statistical computations for generating the statistical models are very long-running, and considerable performance gain can be obtained by using parallel processing on a computational grid. In previous art, this computation grid was often separate and distinct from the data grid, and the modeling applications running on it required the relevant data to be transferred to it from the data grid (see FIG. 1(a)). However, a big disadvantage of this approach is the cost of transferring the data from the data server to the compute grid, which makes this approach prohibitive or impractical for larger data sets (unless a smaller data sample is used, which as mentioned earlier, has the effect of decreasing the model search quality, and increasing the variability of the model parameter estimates). Subsequently, in previous art, new data mining architectures have been proposed, in which the data mining kernels are tightly integrated into the database layer (see FIG. 1(b)), and this architecture, in addition to minimizing the data transfer costs has the added advantage of providing better data security and privacy, and it also avoids the problems that can arise from having to manage multiple, concurrent data replicas. However, a disadvantage of this architecture is that the data servers, which may already be supporting a transactional or decision support workload, must now also take on the added data-mining computational load.

The present invention, in sharp contrast to this prior art, comprises a flexible architecture in which the database layer can off-load a part of the computational load to a separate compute grid, while at the same time retaining the advantages of the earlier architecture in FIG. 1(b) (viz., minimizing data communication costs, preserving data privacy, and avoiding data replicas). Furthermore, this new architecture is also independently scalable across the dimensions of both the data and the compute grid, so that larger data sets can be used in the analysis, and more extensive analytical computations can be performed to improve the quality and accuracy of the data-mining results. This new architecture is schematically shown in FIG. 1(c).
In overview, the present invention discloses a system comprising:
(i) a data grid comprising a collection of disparate data repositories;
(ii) a compute grid comprising a collection of disparate compute resources; and
(iii) means for combining the data grid and the compute grid so that in operation they are suitable for processing business applications of at least one of data modeling and model scoring.

Preferably, means are provided so that the data grid and the compute grid comprise algorithmic decomposition of a data mining kernel on the data and compute grids thereby enabling parallelism on the respective grids.

Preferably, the data grid comprises a parameterized task estimator for enabling run time estimation and task-resource matching algorithms.

Preferably, the compute grid comprises a set of scheduling algorithms guided by data driven requirements for enabling resource matching and utilization of the compute grid.

Preferably, the compute grid comprises preloaded models for scalable interactive scoring, thereby avoiding the overhead of storing the models in the memory of the data server.

Advantages that flow from this system include the following:

1. We can provide a data-centric architecture for data mining that derives the benefits of grid computing for performance and scalability without requiring changes to existing applications that use data mining via standard programming interfaces such as SQL/MM.

2. We can provide an ability to offload analytics computations from the data server to either high-performance compute servers or to multiple, low-cost, commodity processors connected via local area networks, or even to remote, multi-site compute resources connected via a wide area network.

3. We enable the use of data aggregates to minimize the communication between the data grid and the compute grid.

4. We enable the use of parallelism in the compute servers to improve model quality through more exhaustive model search.

5. We enable an ability to use data parallelism and federated data bases to minimize data access costs or data movement on the data network while computing the required data aggregates for modeling.

### BRIEF DESCRIPTION OF THE DRAWING

FIG. 1 illustrates the evolution of the architecture for a data mining kernel, from the client implementation in FIG. 1(a), to a database-integrated implementation in FIG. 1(b), to the current invention comprising of a grid-enabled, database-integrated implementation in FIG. 1(c);

FIG. 2. illustrates schematically the decomposition of the data mining kernel between the data grid and compute grid;

FIG. 3 illustrates schematically the grid-enabled architecture for data mining;

FIG. 4 illustrates schematically the functional decomposition of the data mining kernel and the individual components of the data mining architecture;

FIG. 5 is a functional block diagram emphasizing the data grid and the flowchart for modeling in accordance with the invention;

FIG. 6 is a functional block diagram of the parallel implementation of the data aggregation in the data grid in accordance with the invention;

FIG. 7 is a functional block diagram emphasizing the compute grid and the flowchart for model scoring in accordance with the invention;

FIG. 8 is a functional block diagram of the data grid and compute grid for model scoring in accordance with the invention.

### DETAILED DESCRIPTION OF THE INVENTION

The details of the present invention, both as to its structure and operation, can best be understood in reference to the accompanying drawings, in which like reference numerals refer to like parts.

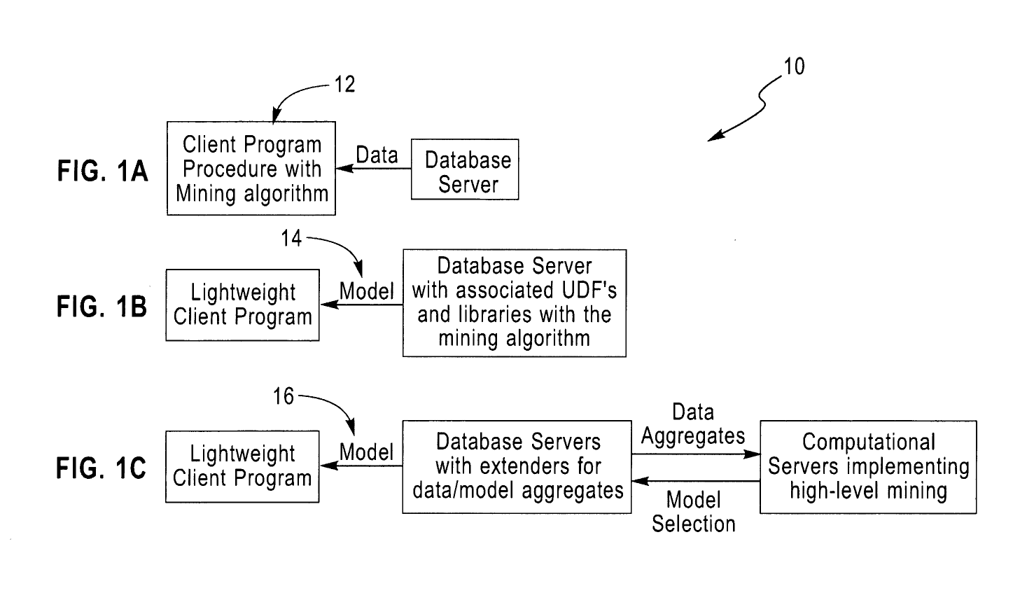

FIG. 1 (numeral 10) comprises FIGS. 1(a), 1(b), and 1(c).

FIG. 1(a) (numeral 12) shows a client-based data mining architecture that is typical of previous art, and this architecture is useful for carrying out data mining studies in an experimental mode, for preliminary development of new algorithms, and for testing parallel or high-performance implementations of various data mining kernels. In recent years, the commercial emphasis has been on the architecture in FIG. 1(b) (numeral 14) where the model generation and scoring subsystems are implemented as database extenders for a set of robust, well-tested data mining kernels. All major database vendors now support integrated mining capabilities on their platforms. The use of accepted or de-facto standards such as SQL/MM, which is a SQL-based API for task and data specification (ISO/IEC 13249 Final Committee Draft, Information Technology—Database Languages—SQL Multimedia and Application Packages, http://www.iso.org, 2002), and PMML, which is a XML-based format for results reporting and model exchange (Predictive Modeling Markup Language, http://www.dmg.org, 2002), enables these integrated mining kernels to be easily incorporated into the production workflow of data-centric business applications. Furthermore, the architecture in FIG. 1(b) has the advantage over that in FIG. 1(a) that the data modeling can be triggered based on the state of internal events recorded in the database.

The data mining architecture in FIG. 1(c) (numeral 16) is a grid-based data mining approach whose relevance and capabilities for enterprise-scale data mining relative to that in FIG. 1(a) and FIG. 1(b) are considered below.

First, we note that any client application in FIG. 1(a) can be recast as a grid application, and can be invoked through the database layer using the SQL/MM task and metadata specification (the training data can either be pushed from the data server as part of the grid task invocation, or a data connection reference can be provided to enable the grid task to connect itself to the data source). Although this does not address the issue of the data transfer overhead, nevertheless, this approach combines all the remaining advantages of FIG. 1(a) and 1(b) mentioned earlier.

Second, most stored procedure implementations of common mining kernels are straightforward adaptations of existing client-based programs. Although the stored procedure approach avoids the data transfer costs to external clients, and can also take advantage of the better I/O throughput from the parallel database subsystem to the stored procedure, it ignores the more significant performance gains obtained by reducing the traffic on the database subsystem network itself (for partitioned databases), or by reducing thread synchronization and serialization during the database I/O operations (for multi-threaded databases).

Third, is it difficult to directly adapt existing data-parallel client programs as stored procedures, because the details of the data placement and I/O parallelism on the database server are managed by the database administration and system policy and by the SQL query optimizer, and are not exposed to the application program.

Fourth, as data mining applications grow in importance, they will have to compete for CPU cycles and memory on the database server with the more traditional transaction processing, decision support and database maintenance workloads. Here, depending on service-level requirements for the individual components in this workload, it may be necessary to offload data mining calculations in an efficient way to other computational servers for peak workload management.

Fifth, the outsourcing of the data mining workloads to external compute servers is attractive not only as a computational accelerator, but also because it can be used to improve the quality of data mining models, using algorithms that perform more extensive model search and optimization, particularly if the associated distributed computing overheads can be kept small.

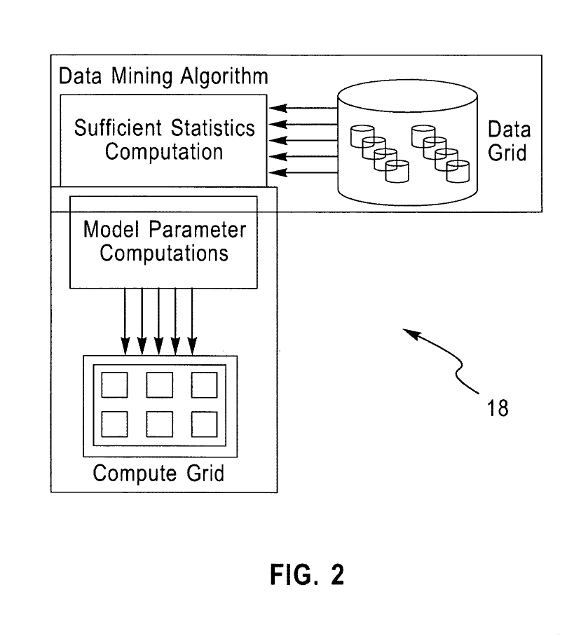

FIG. 2 (numeral 18) schematically illustrates the reformulation of the data mining kernel into two separate functional phases, viz., a sufficient statistics collection phase implemented in parallel on the data grid, and a model selection and parameter estimation phase implemented in parallel on a compute grid, and this reformulation can take good advantage of the proposed grid architecture. Successive iterations of these two functional phases may be used for model refinement and convergence. Here the data grid may be a parallel or federated database, and the compute grid may be high-performance compute-server or a collection of low-cost, commodity processors.

The use of sufficient statistics for model parameter estimation is a consequence of the Neyman-Fisher factorization criterion (M. H. DeGroot and M. J. Schervish, Probability and Statistics, Third Edition, Addison Wesley, 2002), which states that under the assumption that the data consists of an i.i.d sample X₁, X₂, . . . , Xₙ drawn from a probability distribution ƒ(x|θ), where x is a multivariate random variable and θ is a vector of parameters, then the set of functions S₁(X₁, X₂, . . . , Xₙ), . . . , Sₖ(X₁, X₂, . . . , Xₙ) of the data are sufficient statistics for θ, if and only if the likelihood function defined as
L(X₁, X₂, . . . , Xₙ)=ƒ(X₁|θ)ƒ(X₂|θ) . . . ƒ(Xₙ|θ),
can be factorized in the form,
L(X₁, X₂, . . . , Xₙ)=g₁(X₁, X₂, . . . Xₙ)g₂(S₁, . . . , Sₖ, θ),
where g₁ is independent of θ, and g₂ depends on the data only through the sufficient statistics. A similar argument holds for conditional probability distributions ƒ(y|x,θ), where (x,y) are joint multi-variate random variable (the conditional probability formulation is required for classification and regression applications with y denoting the response variable). The cases for which the Neyman-Fisher factorization criterion holds with small values of k are interesting, since the sufficient statistics S₁S₂, . . . , Sₖ, not only gives a compressed representation of the information in the data needed to optimally estimate the model parameters θ using maximum likelihood, but they can also be used to provide a likelihood score for a (hold-out) data set for any given values of the parameters θ (the function g₁ is a multiplicative constant for a given data set that can be ignored for comparing scores). This means that both model parameter estimation and validation can be performed without referring to the original training and validation data.

In summary, the functional decomposition of the mining kernel can be shown to have several advantages for a grid-based implementation.

First, many interesting data mining kernels can be adapted to take advantage of this algorithmic reformulation for grid computing, which is a consequence of the fact that there is a large class of distributions for which the Neyman-Pearson factorization criterion holds with a compact set of sufficient statistics (for example, these include all the distributions in the exponential family such as Normal, Poisson, Log-Normal, Gamma, etc.).

Second, for these many of these kernels, the size of the sufficient statistics is not only significantly smaller than the entire data set which reduces the data transfer between the data and compute grids, but in addition, the sufficient statistics can also be computed efficiently in parallel with minimal communication overheads on the data-grid subsystem.

Third, the benefits of parallelism for these new algorithms can be obtained without any specialized parallel libraries on the data or compute grid (e.g., message passing or synchronization libraries). In most cases, the parallelism is obtained by leveraging the existing data partitioning and query optimizer on the data grid, and by using straightforward, non-interacting parallel tasks on the compute grid.

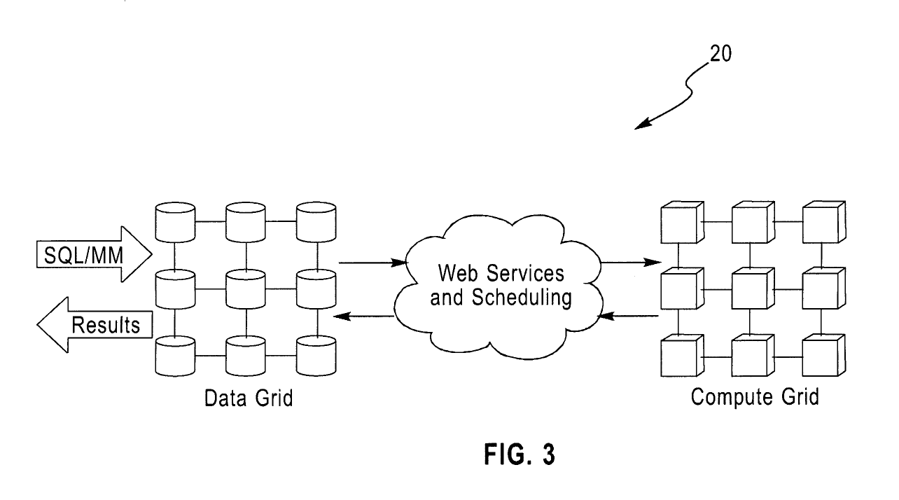

FIG. 3 (numeral 20) shows the overall schematic for grid-based data mining which consists of a parallel or federated database, a web service engine for task scheduling and monitoring, and a compute grid. Each of these components is described in greater detail below.

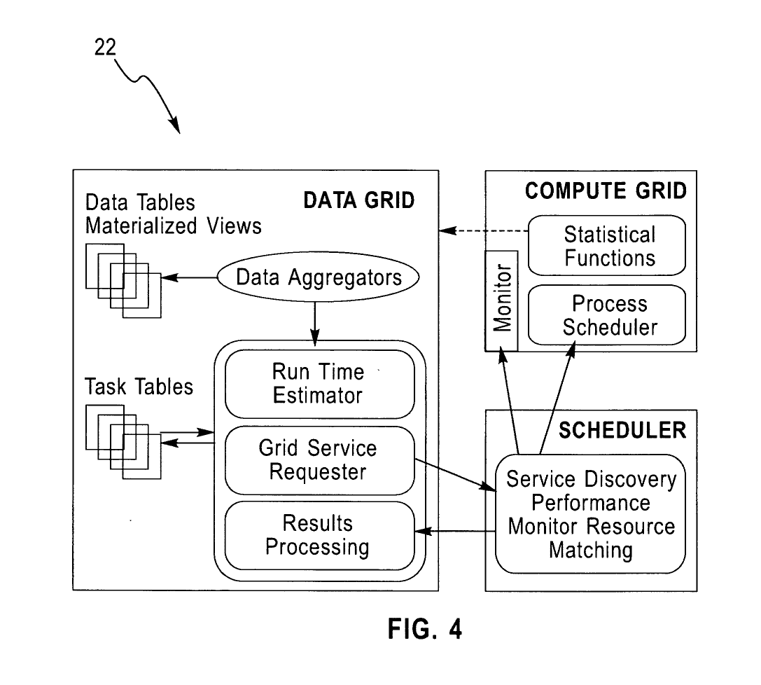

FIG. 4 (numeral 22) is a functional schematic describing the various components in FIG. 3. Our description for the data grid layer will refer to the DB2 family of products (The IBM DB2 Universal Database V8.1, http://www.ibm.com/software/data/db2, 2004), although the details are quite generic and can be ported to other commercial relational databases as well.

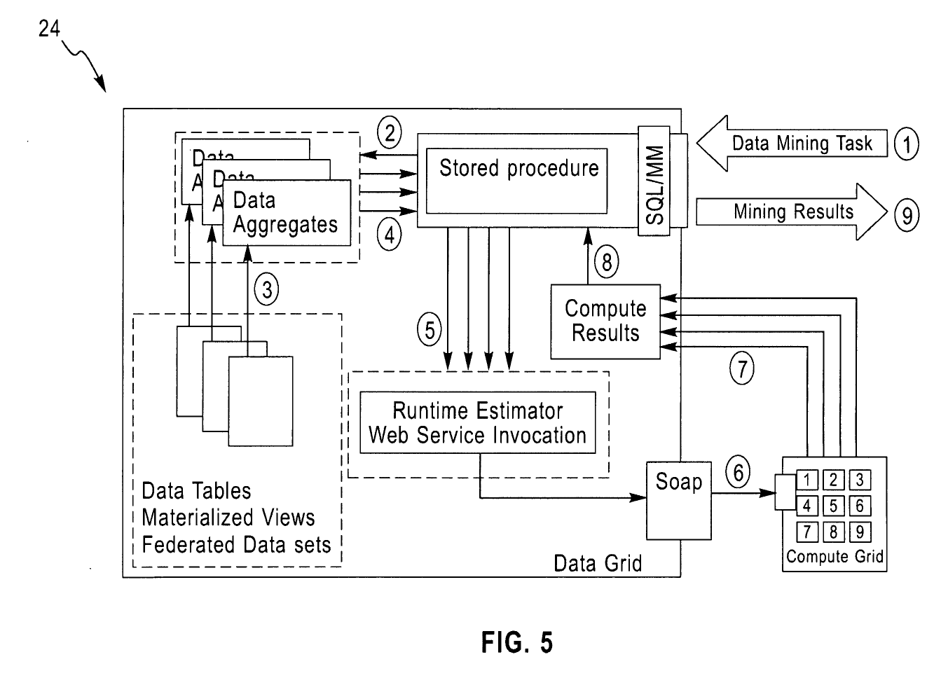

FIG. 5 (numeral 24) is a detailed functional schematic emphasizing the data grid layer of the architecture. This layer implements the SQL/MM interface for data mining task specification and submission. A stored procedure performs various control-flow and book-keeping tasks, such as for example, issuing parallel queries for sufficient statistics collection, invoking the web service scheduler for parallel task assignment to the compute grid, aggregating and processing the results from the compute grid, managing the control flow for model refinement, and exporting the final model.

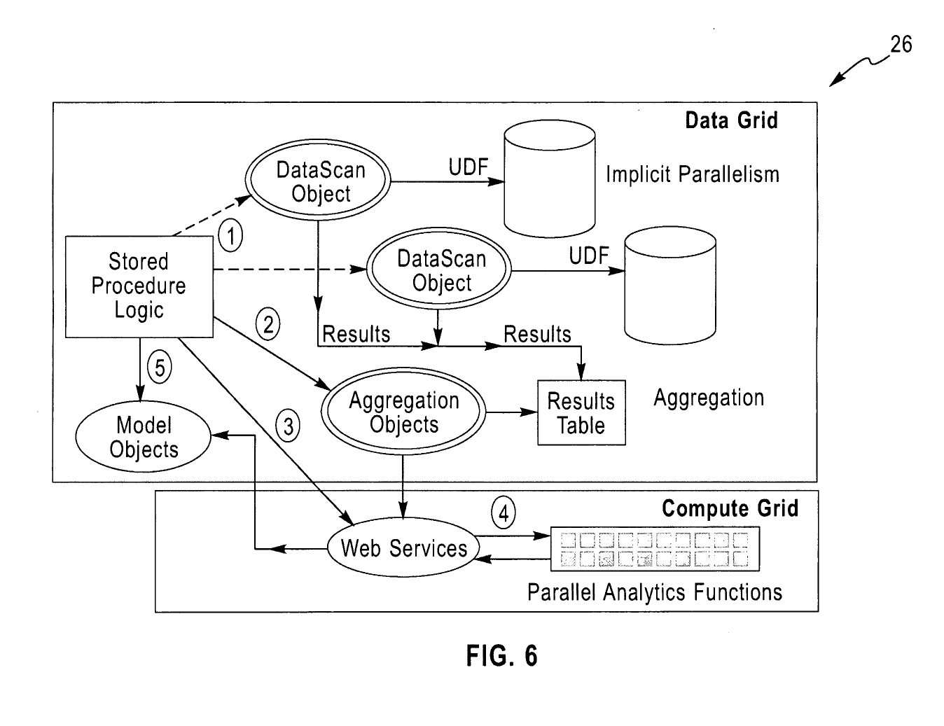

Many parallel databases provide built-in parallel column functions like MAX, MIN, AVG, SUM and other common associative-commutative functions, but do not yet provide an API for application programmers to implement general-purpose multi-column parallel aggregation operators (M. Jaedicke and B. Mitschang, “On Parallel Processing of Aggregate and Scalar Function in Object-Relational DBMS,” Proc. ACM SIGMOD Int. Conf. on Management of Data, Seattle Wash., 1998). Nevertheless, FIG. 6 (numeral 26) shows schematically how these parallel data aggregation operators for accumulating the sufficient statistics can be implemented using scratchpad user defined functions, which on parallel databases leverage the parallelism in the SQL query processor (in both shared-memory and distributed memory parallel modes, or both) by using independent scratchpads for each thread or partition as appropriate. For federated databases, these data aggregation operators would be based on the federated data view, but would leverage the technologies developed for the underlying federated query processor and its cost model in order to optimize the trade-offs between function shipping, data copying, materialization of intermediate views, and work scheduling and synchronization on the components of the federated view to compute the sufficient statistics in the most efficient way (M. Atkinson, A. L. Chervenak, P. Kunszt, I. Narang, N. W. Paton, D. Pearson, A. Shoshani, and P. Wilson, “Data Access, Integration and Management,” Chapter 22, The Grid: Blueprint for a New Computing Infrastructure, Second Edition” (eds., I. Foster and C. Kesselman), Morgan Kaufman, 2003; M. Rodriguez-Martinez and N. Roussopoulos, “MOCHA: A Self-Extensible Database Middleware System for Distributed Data Sources,” Proc. ACM SIGMOD International Conference for Distributed Data Sources, Dallas Tex., pp. 213-224, 2000; D. Kossmann, Franklin, M. J. and Drasch G., “Cache investment: integrating query optimization and distributed data placement,” ACM Transactions on Database Systems, Vol. 25, pp. 517-558, 2000). In summary, the data aggregation operation for the computation of the sufficient statistics can be performed on a parallel or partitioned database or on federated database system by taking advantage of the parallel capabilities of the underlying query processor, to perform local aggregation operations. The results of the local aggregation can then be combined using shared memory (on shared memory systems) or shared disk (on distributed memory systems) or using a table within the database (on database systems where user-defined functions are allowed to write and update database tables), for communicating the intermediate results for final aggregation across the partitions. FIG. 6 also shows a web service (which is in fact a task scheduler as discussed further below) being invoked by the stored procedure, using which the sufficient statistics of independent models accumulated in the data aggregation step are passed from the database to the compute grid for independent execution of the statistical computations on the individual compute nodes.

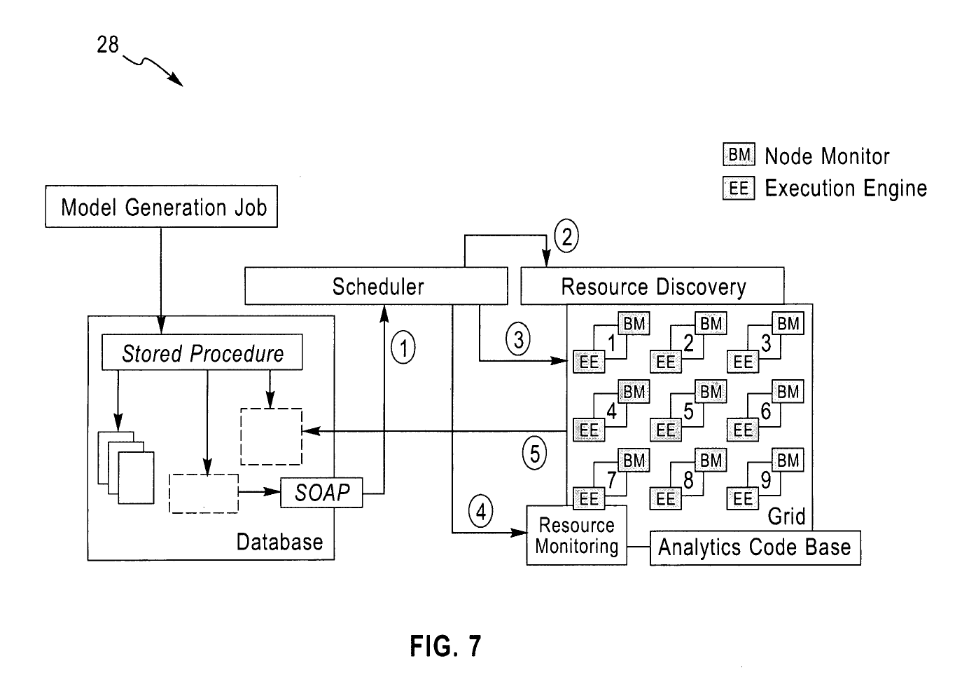

FIG. 7 (numeral 28) shows the task scheduler, which is implemented as a web service for full generality, and can be invoked from SQL queries issued from the database stored procedure. In the case of DB2, the SOAP messaging capabilities provided by a set of user defined functions are used for invoking remote web services with database objects as parameters, as provided in the XML extender (The IBM DB2 XML Extender, http://www.ibm.com/software/data/db2/extender/xmlext, 2004). This invocation of the scheduler is asynchronous, and the parameters that are passed to the scheduler include the task metadata and the relevant task data aggregate. It also includes a runtime estimate for the task, parameterized by CPU speed and memory requirements. In the special case when the compute grid is co-located within the same administrative domain as the data grid, rather than passing the data aggregate as an in-line task parameter, a connection reference to this data is passed instead to the scheduler. This connection reference can be used by the corresponding remote task on the compute grid to retrieve the relevant data aggregate, thereby avoiding the small but serial overhead of processing a large in-line parameter through the scheduler itself. The task scheduler, which shields the data layer from the details of the compute grid, has modules for automatic discovery of compute resources with the relevant compute task libraries, built-in scheduling algorithms for load balancing, task-to-hardware matching based on the processor and memory requirements, polling mechanisms for monitoring task processes, and task life-cycle management including mechanisms for resubmitting incomplete tasks. The parameterized runtime estimates for the tasks are combined with the server performance statistics for task matching, load balancing and task cycle management (which includes the diagnosis of task failures or improper execution on the compute grid). The scheduler can also implement various back-end optimizations to reduce task dispatching overheads on trusted compute-grid resources. Empirical measurements of the task scheduling overheads are used to determine the granularity of the scheduled tasks that are necessary to obtain the linear speedup regime on the compute grid.

FIG. 7 gives a detailed functional schematic of the compute grid layer, which contains the code base for high-level mining services including numerically-robust algorithms for parameter estimation and feature selection from the full input data, or from the sufficient statistics of the data where applicable. The compute grid nodes also contain the resource discovery and resource monitoring components of the task scheduler, which collect node performance data that are used by the scheduler for task matching as described above. The hardware platforms appropriate for the compute grid range from commodity processors on a LAN to high-performance external compute servers, and even multi-site remote compute servers.

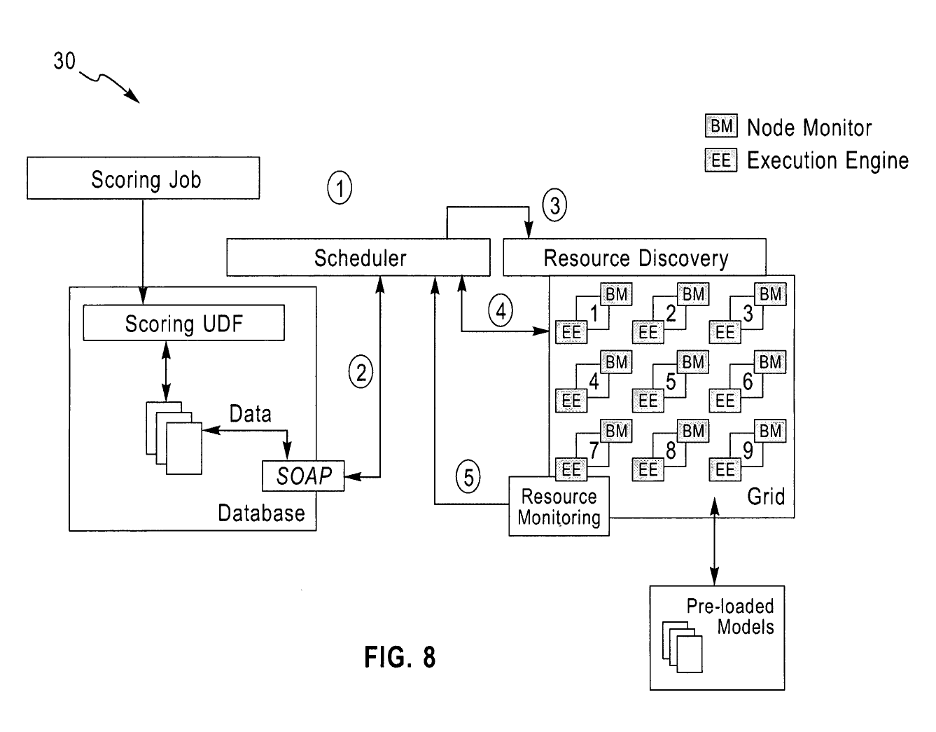

FIG. 8 (numeral 30) schematically shows the use of the data grid, task scheduler and the compute grid layer as described in FIGS. (5)-(7) for a real-time model scoring architecture. In a batch scoring request, where several data records are scored simultaneously, the cost of loading the model into the memory of the database server can be amortized over the data records. However, for interactive scoring requests, this model loading can be the dominant cost, even though the computation associated with each model application may not be large. Furthermore, keeping these models pre-loaded on the database server can also be prohibitive in terms of memory requirements. Therefore, in this case, it is practical to use a compute grid for model scoring, since the memory overhead of pre-loaded models may have less of an impact in the relatively larger memory resource available on the compute servers. The flow chart for an interactive model scoring request is shown in FIG. 7, where the data layer is responsible for marshalling the data and invoking the web scheduler, which can identify the node on the compute grid where required model has been pre-loaded for scoring the data. As in the modeling case, this architecture is also scalable and can use parallelism on the data server and on the compute servers for handling large interactive scoring workloads.

### PARTICULAR EMBODIMENTS OF THE INVENTION

The data mining architecture in the invention as described above is consistent with many data mining algorithms previously formulated in the literature. For example, as a trivial case, the entire data set is a sufficient statistic for any modeling algorithm (although not a very useful one from the data compression point of view), and therefore, sending the entire data set is identical to the usual grid-service enabled client application on the compute grid. Another example is obtained by matching each partition of a row-partitioned database table to a compute node on a one-to-one basis, which leads to distributed algorithms where the individual models computed from each separate data partitions are combined using weighted ensemble-averaging to get the final model (A. Prodromides, P. Chan and S. Stolfo, “Meta learning in distributed data systems—Issues and Approaches,” Advances in Distributed Data Mining, eds. H. Kargupta and P. Chan, AAAI Press, 2000). Yet another example is bagging (L. Breiman, “Bagging Predictors,” Machine Learning, Vol. 24, No. 2, pp. 123-140, 1996), where multiple copies obtained by random sampling with replacement from the original full data set, are used by distinct nodes on the compute grid to construct independent models; the models are then averaged to obtain the final model. The use of competitive mining algorithms provides another example, in which identical copies of the entire data set are used on each compute node to perform parallel independent searches for the best model in a large model search space (P. Giudici and R. Castelo, “Improving Markov Chain Monte Carlo Model Search for Data Mining,” Machine Learning, Vol. 50, pp 127-158, 2003). All these algorithms fit into the present framework, and can be more efficient if the sufficient statistics, instead of the full data, can be passed to the compute nodes.

There is also a considerable literature on the implementation of well-known mining algorithms such as association rules, K-means clustering and decision trees for database-resident data. Some of these algorithms are client application or stored procedures that are structured so that rather than copying the entire data, or using a cursor interface to the data, they directly issue database queries for the relevant sufficient statistics. For example, Graefe, G.; U. Fayyad and S. Chaudhuri, “On the efficient gathering of sufficient statistics for classification from large SQL databases,” Proceedings Fourth International Conference on Knowledge Discovery and Data Mining,” AAAI Press, Menlo Park, pp.204-208, 1998 consider a decision tree algorithm in which for each step in the decision tree refinement, a database query is used to return the relevant sufficient statistics required for that step (the sufficient statistics in this case comprise of the set of all bi-variate contingency tables involving the target feature at each node of the current decision tree). These authors show how the relevant query can be formulated so that the desired results can be obtained in a single database scan. The issue of obtaining the sufficient statistics for decision tree refinement, but in the distributed data case when the data tables are partitioned by rows and by columns respectively has also been considered (D. Caragea, A. Silvescu and V. Honavar, “A Framework for Learning from Distributed Data Using Sufficient Statistics and its Application to Learning Decision Trees,” Int. J. Hybrid Intell. Syst., Vol. 1, pp. 80-89, 2004). These approaches, however, do not focus on the computational requirements in the stored procedure, which are quite small for decision tree refinement and offer little scope for the use of computational parallelism

There is related work on pre-computation or caching of the sufficient statistics from data tables for specific data mining kernels. For example, a sparse data structure for compactly storing and retrieving all possible contingency tables that can be constructed from a database table, which can be used by many statistical algorithms, including log-linear response modeling has been described (A. Moore and Mary Soon Lee, “Cached Sufficient Statistics for Efficient Machine Learning with Massive DataSets,” Journal of Artificial Intelligence Research, Vol. 8, pp. 67-91, 1998). A related method, termed squashing (W. DuMouchel, C. Volinsky, T. Johnson, C. Cortes and D. Pregibon, “Squashing Flat Files Flatter,” Proceedings of the Fifth International Conference on Knowledge Discovery and Data Mining, pp. 6-15, 1999), derives a small number of pseudo data points and corresponding weights from the full data set, so that the low-order multivariate moments of the pseudo data set and the full data set are equivalent; many modeling algorithms such as logistic regression use these weighted pseudo data points, which can be regarded as an approximation to the sufficient statistics of the full data set, as a computationally-efficient substitute for modeling purposes.

We see the main advantage for the present invention for data mining in the context of segmentation-based data modeling. In commercial applications of data mining, the primary interest is often in extending, automating and scaling up the existing methodology that is already being used for predictive modeling in specific industrial applications. Of particular interest is the problem of dealing with heterogeneous data populations (i.e., data that is drawn from a mixture of distributions). A general class of methods that is very useful in this context is segmentation-based predictive modeling (C. Apte, R. Natarajan, E. Pednault, F. Tipu, A Probabilistic Framework for Predictive Modeling Analytics, IBM Systems Journal, V. 41(3), 2002). Here the space of the explanatory variables in the training data is partitioned into mutually-exclusive, non-overlapping segments, and for each segment the predictions are made using multi-variate probability models that are standard practice in the relevant application domain. These segmented models can achieve a good balance between the accuracy of local models, and the stability of global models.

The overall model naturally takes the form of “if-then” rules, where the “if” part defines the condition for segment membership, and the “then” part defines the corresponding segment predictive model. The segment definitions are Boolean combinations of uni-variate tests on each explanatory variable, including range membership tests for continuous variables, and subset membership tests for nominal variables (note that these segment definitions can be easily translated into the where-clause of an SQL query to retrieve all the data in corresponding segment).

The determination of the appropriate segments and the estimation of the model parameters in the corresponding segment models can be carried out by jointly optimizing the likelihood function of the overall model for the training data, with validation or hold-out data being used to prevent model over-fitting. This is a complex optimization problem involving search and numerical computation, and a variety of heuristics including top-down segment partitioning, bottom-up segment agglomeration, and combinations of these two approaches are used in order to determine the best segmentation/segment-model combination. The segment models that have been studied include a bi-variate Poisson-Lognormal model for insurance risk modeling (C. Apte, E. Grossman, E. Pednault, B. Rosen, F. Tipu, and B. White, “Probabilistic Estimation Based Data Mining for Discovering Insurance Risks ,” IEEE Intelligent Systems, Vol. 14(6), 1999), and multivariate linear and logistic regression models for retail response modeling (R. Natarajan and E. P. D. Pednault, “Segmented Regression Estimators for Massive Data Sets,” Proc. Second SIAM Conference on Data Mining, Crystal City Va., 2002). These algorithms are also closely related to model-based clustering techniques (e.g., C. Fraley, “Algorithms for Model-Based Gaussian Hierarchical Clustering,” SIAM J. Sci. Comput., V. 20, No. 1, pp. 270-281 1988).

The potential benefits of the data mining architecture in the present invention for segmentation-based models can be examined using the following model. We assume a data grid with P₁ processors, and a compute grid with P2 processors. On each node of the data and compute grid, the time for 1 floating point operation (flop) is denoted by α₁ and α₂ respectively, and the time for accessing a single data field on the database server is denoted by β₁. Finally the cost of invoking a remote method from the data grid onto the compute grid is denoted by γ₁+γ₂w, where γ₁ is the latency for remote method invocation, γ₂ is the cost per word for moving data over the network, and w being the size of the data parameters that are transmitted. Further, the database table used for the modeling consists of n rows and m columns, and is perfectly row-partitioned so that each data grid partition has n/P₁ rows (we ignore the small effects when n is not perfectly divisible by P₁).

Using this model, we consider one pass of a multi-pass a segmented predictive model evaluation (e.g., R. Natarajan and E. P. D. Pednault, op. cit.), and assume that there are N segments, which may be overlapping or non-overlapping, for which the segment regression models have to be computed (typically N>>P₁,P₂). The sufficient statistics for this step are a pair of covariance matrices (training+evaluation) for the data in each segment, which are computed for all N segments in a single parallel scan over the data table. The time T_{D} for the data aggregation can be shown to be (β₁nm+0.5α₁knm²)/P₁+α₁NP₁m², where k<N denotes the number of segments that each data record on average contributes to, with k=1 corresponding to the case of non-overlapping segments. The three terms in this data aggregation time above correspond respectively to the time for reading the data from the database, the time for updating the covariance matrices locally, and the time for aggregating the local covariance matrix contributions at the end of a data scan. These sufficient statistics are then dispatched to a compute node, for which the scheduling time Tₛ can be estimated as γ₁+γ₂Nm²/P₂. On the compute nodes, a greedy forward-feature-selection algorithm is performed in which features are successively added to a regression model, based on obtaining the model parameters from the training data sufficient statistics, and the degree-of-fit fit by using these models with evaluation data sufficient statistics. The overall time T_{c} for the parameter computation and model selection step can be shown to be

$$\frac{1}{12} {α}_{2} {Nm}^{4} / {P}_{2} ,$$

where only leading order terms for large m have been retained. The usual algorithms for the solution of the normal equations by the Choleski factorization algorithm are O(m³) (e.g., R. Natarajan and E. P. D. Pednault, op. cit.), but incorporating the more rigorous feature selection algorithm using evaluation data as proposed above, pushes the complexity up to O(m⁴)). The total time is thus given by

$$\begin{matrix}T = {T}_{D} + {T}_{S} + {T}_{C} \\ = ( {β}_{1} n m + 0.5 {α}_{1} k n {m}^{2} ) / {P}_{1} + {α}_{1} N {P}_{1} {m}^{2} + \\ {γ}_{1} + {γ}_{2} {Nm}^{2} / {P}_{2} + \frac{1}{ 12} {α}_{2} {Nm}^{4} / {P}_{2}\end{matrix}$$

We consider some practical examples for data sets that are representative of retail customer applications with n=10⁵, m=500, and k=15, N=500, and typical values α₁=α₂=2×10⁻⁸ sec, β₁=5×10⁻⁶ sec/word, γ₁=4×10⁻² sec, γ₂=2×10⁵ sec/word for the hardware parameters. For the case P₁=1, P₂=0, when all the computation must be performed on the data grid, the overall execution time is T=7.8 hours (in this case there is no scheduling cost as all the computation is performed on the data server itself). For the case, P₁=1, P₂=1, we have the execution time increasing to T=8.91 hours (T_{D}=0.57 hours, Tₛ=1.11 hours, T_{c}=7.23 hours), which is an overhead of 14% although 80% of the overall time has been off-loaded from the data server. However, by increasing the number of processors on the data and compute grids to P₁=16, P₂=128, the execution time comes down to T=0.106 hours (T_{D}=0.041 hours, Tₛ=0.009 hours, T_{c}=0.057 hours) which is a speedup of about 74 over the base case when all the computation is performed on the data server.

We have intentionally used modest values for n, m in the analysis given above, and many retail data sets can have millions of customers records, and the number of features can also increase dramatically depending on the number of interaction terms involving the primary features that are incorporated in the segment models (for example, quadratic, if not higher interaction terms, may be used to accommodate nonlinear segment model effects, with the trade-off that the final predictive model may have fewer overall segments, albeit with more complicated models within each segment). The computational analysis suggests that an increase in the number of features for modeling would make the use of a separate compute grid even more attractive for this application.

We believe that many applications that use segmentation-based predictive data modeling problems are ideally suited for the proposed grid architecture, and a detailed analysis indicates the comparable costs and the need for parallelism in both data access and sufficient statistics computations on the data grid, as well as in the model computation and search on the compute grid. These modeling runs are estimated to require several hours of computational time running serially on current architectures using the computational model described above.

What is claimed:

1. A system comprising:
(i) a data grid comprising a collection of disparate data repositories;
(ii) a compute grid comprising a collection of disparate compute resources; and
(iii) means for combining the data grid and the compute grid so that in operation they are suitable for processing business applications of at least one of data modeling and model scoring.

2. A system according to claim 1, comprising means so that the data grid and the compute grid include algorithmic decomposition of a data mining kernel on the data and compute grids thereby enabling parallelism on the respective grids, while minimizing data transfer between the respective grids.

3. A system according to claim 1, wherein the data grid comprises a parameterized task estimator for enabling run time estimation and task-resource matching algorithms.

4. A system according to claim 1, wherein the compute grid comprises a set of scheduling algorithms guided by data driven requirements for enabling resource matching and utilization of the compute grid.

5. A system according to claim 1, wherein the parallel compute grid comprises numerous preloaded models in the individual node memories for scalable interactive scoring, thereby avoiding the overhead of keeping the models in the limited memory of the data server or reading from the data server disk which limits the required fast interactive response.
